(19) United States
(12) Patent Application Publication
(10) Pub. No.: US 2010/0225079 A1
(43) Pub. Date: Sep. 9, 2010

(54) TW0-WHEEL MOVING DEVICE AND AUTOCYCLE HAVING THAT

(76) Inventors: Yong Bum Kwon, Daegu (KR); Hyun Sik Jang, Gumi-si (KR)

Correspondence Address: KED & ASSOCIATES, LLP, P.O. Box 221200, Chantilly, VA, 20153-1200, US

(21) Appl. No.: 12/681,988

(22) PCT Filed: Oct. 10, 2008
(86) PCT No.: PCT/KR08/05961

§ 371 Date: Apr. 7, 2010

(30) Foreign Application Priority Data
Oct. 11, 2007 (KR) 10-2007-0102456

(51) Int. Cl. B62D 61/06; B62D 61/04

(52) U.S. Cl. 280/64

(57) ABSTRACT

A two-wheel moving device includes a fixed shaft fixed to one side of a body; first and second swing arms having one ends pivotally coupled to the fixed shaft, respectively; a first varying shaft mounted at the other end of the first swing arm in parallel with the fixed shaft; a second varying shaft mounted at the other end of the second swing arm in parallel with the fixed shaft; a first wheel rotatably coupled to the first varying shaft; a second wheel rotatably coupled to the second varying shaft; a first extendable arm having elasticity and having one end coupled to the first swing arm and the other end coupled to the body; a second extendable arm having elasticity and having one end coupled to the second swing arm and the other end coupled to the body; a first motor used for rotating the first wheel; and a second motor used for rotating the second wheel. An autocycle includes such a two-wheel moving device.

### TECHNICAL FIELD

Disclosed herein are a two-wheel moving device whose center of gravity is movable, and an autocycle having the same.

### BACKGROUND ART

Generally, an autocycle is a vehicle operated with one wheel at front and rear sides, respectively. However, a user using such a two-wheeled autocycle may not easily keep a balance while running or stopping, so only skilled persons having practiced a lot can drive the two-wheeled autocycle.

To solve this problem and ensure stable running, a three-wheeled autocycle having two rear wheels or a four-wheel autocycle having two front wheels and two rear wheels were developed.

For example, in case of a three-wheeled autocycle, one front wheel and two rear wheels are equipped such that two rear wheels are arranged in parallel so as to support the weight of the autocycle stably. Thus, the weight of the autocycle is stably distributed to the three wheels, so a beginner or an old or feeble person may easily drive the autocycle.

However, in such a three-wheeled or four-wheel autocycle, the rear wheels or the front wheels equipped in parallel cannot be inclined, so a centrifugal force is not offset during turning. Generally, while the autocycle makes a turn, a centrifugal force is applied in a direction opposite to the center of gravity, namely in an outward direction. Thus, to overcome the centrifugal force, in case a two-wheeled autocycle, a driver inclines the cycle body and/or his/her own body toward the center of gravity. Then, the center of gravity of the cycle body and the driver moves toward a rotation center such that an inclining force of the cycle body or the rider toward the rotation center makes a balance with the centrifugal force, thereby ensuring stable rotation.

But, the cycle body of a three-wheeled or four-wheel autocycle cannot be inclined while the autocycle is turning, so the driver receives the centrifugal force as it is. Thus, the driver may fall on the ground from the autocycle when the autocycle turns fast or if the rider is careless, which may cause injury. In a severe case, the autocycle cannot overcome the centrifugal force and may be overturned.

### DISCLOSURE OF INVENTION

### Technical Problem

In order to solve the above problems, there are provided a two-wheel moving device that may be inclined during turning so as to allow stable turning, and an autocycle having at least one two-wheel moving device to ensure easy driving and stable turning.

### Technical Solution

In an aspect, there is provided a two-wheel moving device, which includes a fixed shaft fixed to one side of a body; first and second swing arms having one ends pivotally coupled to the fixed shaft, respectively; a first varying shaft mounted at the other end of the first swing arm in parallel with the fixed shaft; a second varying shaft mounted at the other end of the second swing arm in parallel with the fixed shaft; a first wheel rotatably coupled to the first varying shaft; a second wheel rotatably coupled to the second varying shaft; a first extendable arm having elasticity and having one end coupled to the first swing arm and the other end coupled to the body; and a second extendable arm having elasticity and having one end coupled to the second swing arm and the other end coupled to the body.

The two-wheel moving device may further include a first motor provided at the first varying shaft and used for rotating the first wheel; and a second motor provided at the second varying shaft and used for rotating the second wheel. This allows the first and second wheels to be operated without any power loss.

Also, in order to drive the first and second wheels, the two-wheel moving device may further include a rotation driving unit provided at the fixed shaft to generate a rotating power; a first power transmission unit connecting the fixed shaft and the first varying shaft and transmitting the rotating power of the rotation driving unit to the first varying shaft; and a second power transmission unit connecting the fixed shaft and the second varying shaft and transmitting the rotating power of the rotation driving unit to the second varying shaft.

In another aspect, there is also provided an autocycle, which includes a body providing a space on which a person rides; a front wheel mounted at a front portion of the body; and a rear wheel mounted at a rear portion of the body, wherein at least one of the front and rear wheels is the above two-wheel moving device.

### Advantageous Effects

In the present invention, two wheels are arranged in parallel to enhance stability during running or stopping, and stable turning is ensured using a structure in which a body may be inclined inward during turning.

### BRIEF DESCRIPTION OF DRAWINGS

FIG. 1 is a side view showing a structure of a two-wheel moving device according to one embodiment of the present invention;

FIG. 2 is a plan view showing the structure of the two-wheel moving device according to one embodiment of the present invention;

FIG. 3 is a schematic view showing that the two-wheel moving device according to one embodiment of the present invention makes a right turn;

FIG. 4 is a schematic view showing that the two-wheel moving device according to one embodiment of the present invention makes a left turn;

FIG. 5 is a side view showing a structure of a two-wheel moving device according to one embodiment of the present invention; and

FIG. 6 is a plan view showing the structure of the two-wheel moving device according to one embodiment of the present invention.

### BEST MODE FOR CARRYING OUT THE INVENTION

Hereinafter, embodiments of the present invention will be described in detail with reference to the accompanying drawings.

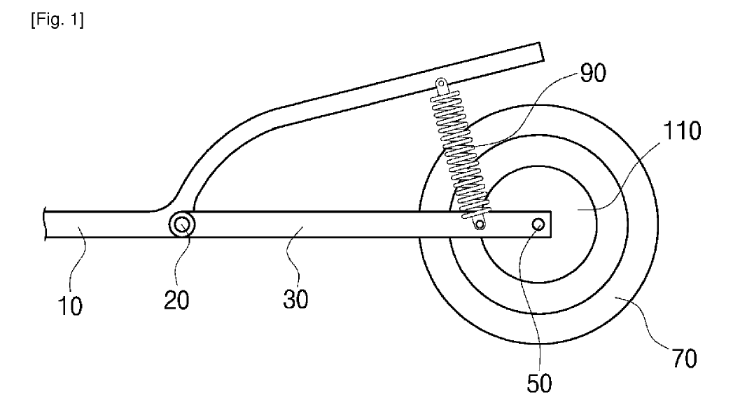

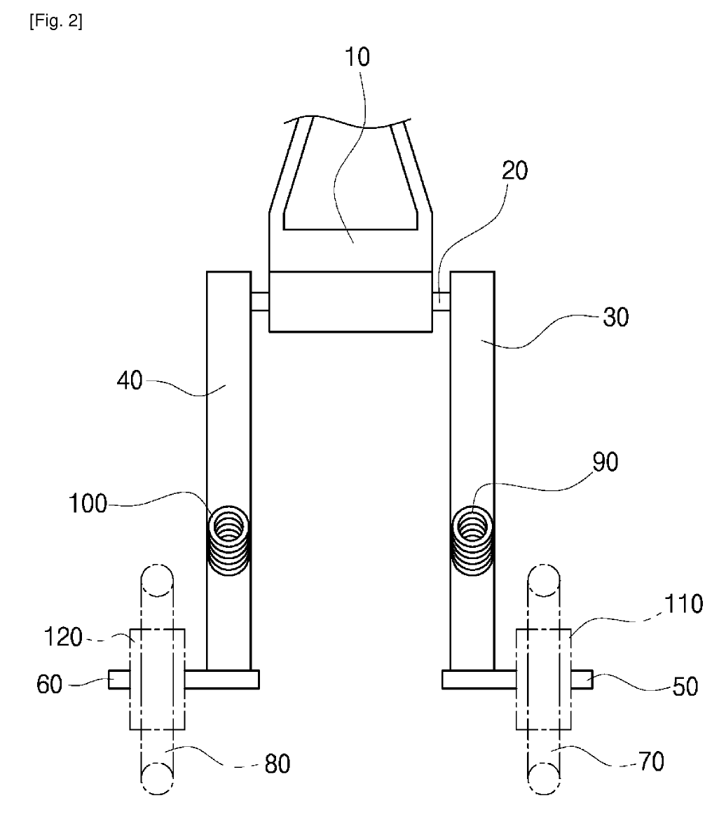

A two-wheel moving device of this embodiment includes a fixed shaft 20, first and second swing arms 30, 40, first and second varying shafts 50, 60, first and second wheels 70, 80, and first and second extendable arms 90, 100, as shown in FIGS. 1 and 2. FIG. 1 is a side view showing a structure of the two-wheel moving device according to this embodiment, and FIG. 2 is a plan view showing the structure of the two-wheel moving device according to this embodiment.

Here, the fixed shaft 20 is fixed to one side of a body 10. The body 10 is a body of an autocycle or the like, and it provides a space on which a person or load may be placed.

One ends of the swing arms 30, 40 are pivotally coupled to the fixed shaft 20, and the swing arms 30, 40 may be swung with respect to the one ends coupled to the fixed shaft 20. In this embodiment, two swing arms are mounted in parallel, and they are called a first swing arm 30 and a second swing arm 40, respectively. The first and second swing arms 30, 40 are arranged in parallel with one ends being disposed at the fixed shaft 20, and the first and second swing arms 30, 40 may be pivoted independently. Also, the swing arms have constant lengths as shown in FIG. 2, and the first and second varying shafts 50, 60 are mounted at the other ends of the swing arms.

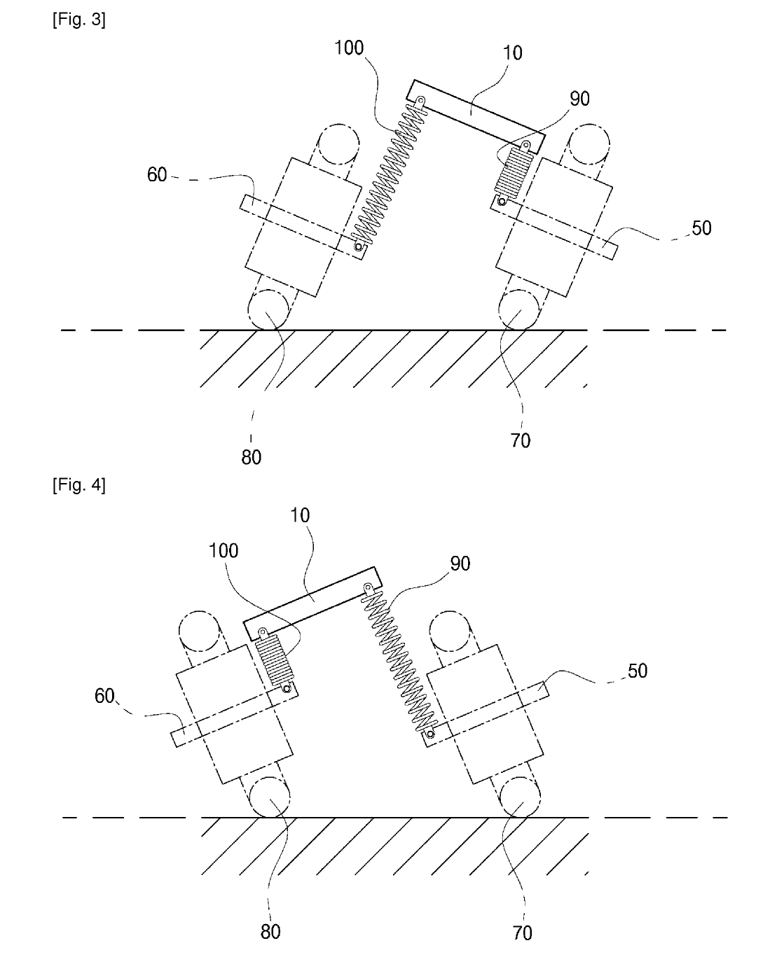

The first and second varying shafts 50, 60 are coupled to the other ends of the first and second swing arms 30, 40 in parallel with the fixed shaft 20. Thus, the varying shafts 50, 60 change their locations by the swing arms 30, 40 while keeping a parallel state with the fixed shaft 20, as shown in FIGS. 3 and 4.

Also, the first and second wheels 70, 80 are rotatably coupled to the first and second varying shafts 50, 60, respectively. Thus, the first and second wheels 70, 80 are rotated with respect to the first and second varying shafts 50, 60, respectively.

Here, the first and second wheels 70, 80 may be configured such that first and second motors 110, 120 are respectively included in wheels thereof, as shown in FIGS. 1 and 2. In case the first and second motors 110, 120 are included in the first and second wheels 70, 80 as mentioned above, the first and second wheels 70, 80 are rotated directly by rotation of the motors, so there is no need of separate power transmission process. Thus, there is no energy loss occurring during the power transmission process.

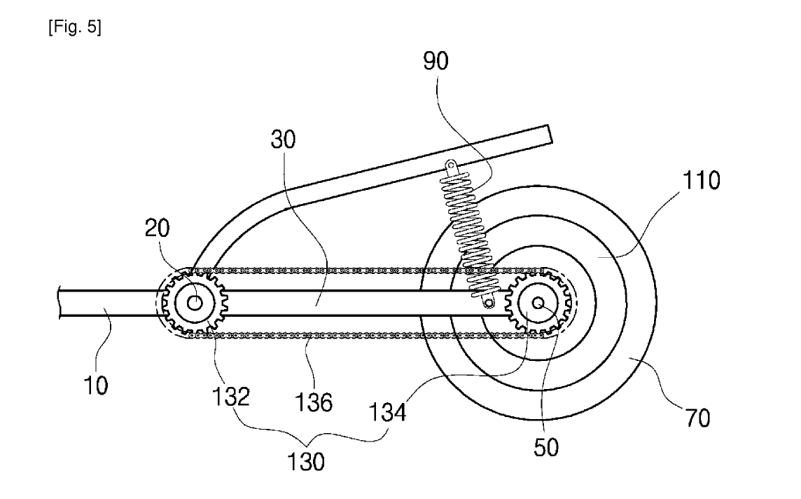

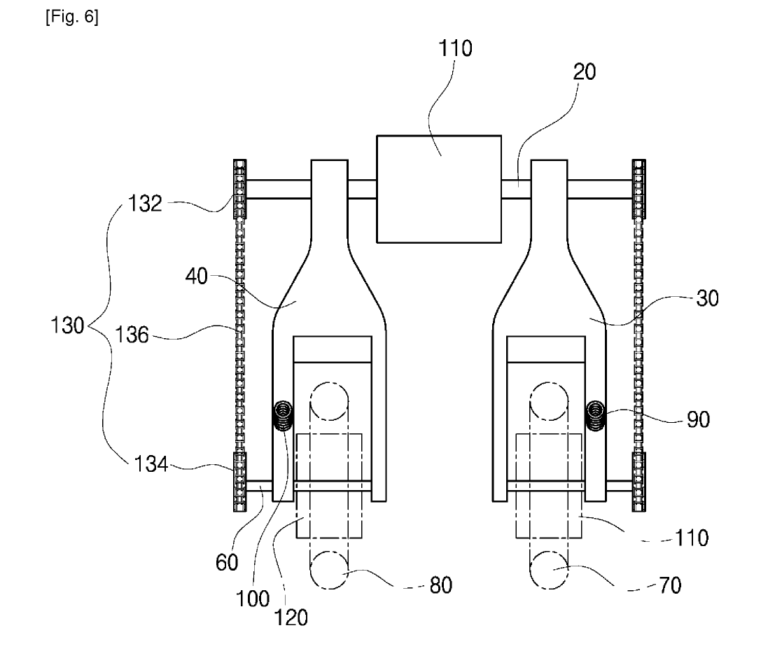

Meanwhile, as shown in FIGS. 5 and 6, a motor 110 may be prepared on the fixed shaft 20, and the power of the motor 110 may be transmitted to the first and second wheels 70, 80 by means of the motor and a power transmission means 130 that connects the first and second wheels 70, 80.

The first extendable arm 90 has elasticity in itself, and the first extendable arm 90 is extendable in its length. One end of the first extendable arm 90 is coupled to one side of the first swing arm 30, and the other end is coupled to the body 10, as shown in FIG. 1. That is to say, the first extendable arm 90 is mounted between the first swing arm 30 and the body 10 to absorb an impact applied between the first swing arm 30 and the body 10 using its elasticity. The two-wheel moving device of this embodiment may not be provided with the extendable arm. But, the extendable arm absorbs impacts and thus gives better comfort to a rider.

Meanwhile, the second extendable arm 100 also has elasticity in itself, and one end of the second extendable arm 100 is coupled to the second swing arm 40 and the other end is coupled to the body 10.

The first and second extendable arms 90, 100 are provided separately to respectively absorb impacts applied between the first and second swing arms 30, 40 and the body 10. Also, by means of the first and second extendable arms 90, 100, gaps between the first and second varying shafts 50, 60 and the body 10 are changed during turning as shown in FIGS. 3 and 4, so the center of gravity may be changed. Such change of the center of gravity decreases a centrifugal force occurring during turning, thereby ensuring stable turning.

Hereinafter, running stability in case a turn is made using the two-wheel moving device configured as above is explained.

In general running, the first and second wheels 70, 80 of the two-wheel moving device are operated in parallel with each other, namely facing each other (in this state, extension lines of the first and second varying shafts 50, 60 coincide with each other). However, during a turn, as shown in FIGS. 3 and 4, the first and second wheels 70, 80 are swung by the first and second swing arms 30, 40 to cross each other, so the first and second wheels 70, 80 do not face each other (in this state, the extension lines of the first and second varying shafts 50, 60 are in parallel, not coinciding with each other).

Namely, in case of a right turn, as shown in FIG. 3, the first extendable arm 90 is shrunken and the second extendable arm 100 is elongated, so the body 10 is inclined to the right. Thus, the center of gravity of the rider and the body 10 is moved rightward on the figure, thereby offsetting the centrifugal force applied to the left.

Meanwhile, in case of a left turn, as shown in FIG. 4, the length of the second extendable arm 100 is shortened and the first extendable arm 90 is elongated, so the body 10 is inclined to the left. Thus, the center of gravity is moved leftward on the figure, thereby offsetting the centrifugal force applied to the right. Thus, stable turning is ensured.

The invention has been described in detail with reference to preferred embodiments thereof. However, it will be appreciated by those skilled in the art that changes may be made in these embodiments without departing from the principles and sprit of the invention, the scope of which is defined in the accompanying claims and their equivalents.

1. A two-wheel moving device, comprising:
a fixed shaft fixed to one side of a body;
first and second swing arms having one ends pivotally coupled to the fixed shaft, respectively;
a first varying shaft mounted at the other end of the first swing arm in parallel with the fixed shaft;
a second varying shaft mounted at the other end of the second swing arm in parallel with the fixed shaft;
a first wheel rotatably coupled to the first varying shaft;
a second wheel rotatably coupled to the second varying shaft;
a first extendable arm having elasticity and having one end coupled to the first swing arm and the other end coupled to the body;
a second extendable arm having elasticity and having one end coupled to the second swing arm and the other end coupled to the body;
a first motor used for rotating the first wheel; and
a second motor used for rotating the second wheel.

2. The two-wheel moving device as claimed in claim 1,
wherein the first motor is provided at the first varying shaft; and
wherein the second motor is provided at the second varying shaft.

3. An autocycle, comprising:
a body providing a space on which a person rides;
a front wheel mounted at a front portion of the body; and
a rear wheel mounted at a rear portion of the body,
wherein the rear wheel is the two-wheel moving device defined in claim 1.

4. An autocycle, comprising:
a body providing a space on which a person rides;
a front wheel mounted at a front portion of the body; and
a rear wheel mounted at a rear portion of the body,
wherein the rear wheel is the two-wheel moving device defined in claim 2.
